(19) United States
(12) Patent Application Publication
(10) Pub. No.: US 2004/0084903 A1
(43) Pub. Date: May 6, 2004

(54) Glue-less head casing assembly of an optical fiber transmission cable

(76) Inventor: Chen-Hung Hung, Chia-Yi Hsien (TW)

Correspondence Address: Chen-Hung Hung, P.O. Box No. 6-57, Chung-Ho, Taipei, 235, TW

(21) Appl. No.: 10/286,830

(22) Filed: Nov. 4, 2002

(51) Int. Cl. F16L 13/14

(52) U.S. Cl. 285/382

(57) ABSTRACT

A glue-less head casing assembly of an optical fiber transmission cable capable of connecting with an optical fiber conductor wire includes a head casing main body and a head socket. A lashing ring is coaxially disposed at a front end of the head casing main body thereby tightly connecting the front end area with an optical fiber core wire of the optical fiber conductor wire; the diameter of a distal end portion of the head socket is reduced by a squeezing tool. The distal end portion with reduced diameter tightly connects with a buffering layer of the optical fiber wire so as to stabilize the transmission of optical signals.

### BACKGROUND OF THE INVENTION

1) Field of the Invention

The present invention relates to a glue-less head casing assembly of an optical fiber transmission cable capable of connecting with an optical fiber conductor wire. A lashing ring inserts at a front end of the head casing assembly thereby tightly connecting the front end area with an optical fiber core wire of the optical fiber conductor wire; a distal end portion of the head casing assembly shrinks and deforms inwardly to reduce the diameter thereof as well as tightly connects with a buffering layer of the optical fiber conductor wire so as to stabilize the transmission of optical signals.

2) Description of the Prior Art

Recently, the advanced technique of telecommunication enables a live time Olympic Game held on one side of the globe to be viewed simultaneously by the television audience on another side. In the future, it is very possible and easy to implement the television for medical and educational purposes, the electronic transmission of mail and news, the popularization of family combined telecommunication, information transmission and television-telephone. Therefore, the telecommunication capacity has to be augmented in hundred times. The features of an optical fiber include small diameter, wide band area and low damage; that makes the optical fiber the main material used for transmission channel in the telecommunication industry of transmitting such a large capacity of information.

The present operation of constructing an optical fiber telecommunication system uses a main line for transmission channel; a plurality of branch lines derive from the main line; the branch lines transmit the optical signals to each user end. A plurality of optical fiber jump joint cables (transmission cables) interconnect to increase the distance of the optical fiber communication.

As indicated in FIGS. 1 and 2, a conventional optical fiber jump joint cable (transmission cable) includes a head casing assembly (1) connecting with an optical fiber conductor wire (2). The head casing assembly (1) comprises a main body (3) and a head socket (4) connected with an end of the main body (3). A through receiving slot (5) communicates with a channel slot (6) of the head socket (4). The optical fiber conductor wire (2) has at least one optical core wire (7), a shielding layer (8) covering the outer portion of the optical fiber core wire (7) and a buffering layer (9) covering the outer peripheral portion of the shielding layer (8). When in use, parts of the shielding layer (8) and the buffering layer (9) have to be removed to expose a certain length of the optical fiber core wire (7). In addition, the outer portions of the optical fiber core wire (7) and the buffering layer (9) are spread with hot positioning glue (10) for connecting with the head casing assembly (1). The final connection positions the optical fiber core wire (7) inside the receiving slot (5) of the main body (3) and the buffering layer (9) inside the channel slot (6) of the head socket (4). When the hot positioning glue (10) hardens, the optical fiber conductor wire (2) is firmly positioned in the head casing assembly (1).

The head casing assembly (1) and the optical fiber conductor wire (2) are fixed by the hot positioning glue (10); however, air bubbles tend to appear in the hot positioning glue (10) and the glue has thermal expansion and contraction; therefore, the positions of optical points shift thereby reducing the transmission quality of the optical signals. Various environmental factors, such as temperature difference and vibration, change the specialty of the hot positioning glue (10). This undesired situation needs improvement.

Furthermore, the hot positioning glue (10) requires the following process operations: gluing, baking, removing the glue on the end head of the optical fiber core wire and grinding. Therefore, it is necessary to consider the cost and time increased by such complicated operations.

### SUMMARY OF THE INVENTION

In viewing and in order to improve the abovementioned shortcomings of the prior art, the primary objective of the present invention is to provide a glue-less head casing assembling of an optical fiber transmission cable; wherein a lashing ring is coaxially disposed at a front end of the head casing assembly; the clamping force of the lashing ring tightly connects an optical fiber core wire of an optical fiber conductor wire with a head casing main body; a diameter of a distal end portion of the head socket is reduced by a special squeezing tool such that the distal end area of the head socket tightly connects with a buffering layer of the optical fiber conductor wire so as to stabilize the transmission of optical signals.

To enable a further understanding of the structural features and the technical contents of the present invention, the brief description of the drawings below is followed by the detailed description of the preferred embodiment.

### BRIEF DESCRIPTION OF THE DRAWINGS

FIG. 1 is a cross-sectional drawing of the connection of a conventional head casing assembly and a distal end of an optical fiber conductor wire.

FIG. 2 is a cross-sectional drawing of the connection of the present invention of a glue-less head casing assembly and a distal end of an optical fiber conductor wire.

FIG. 3 is a cross-sectional drawing of the glue-less head casing assembly of the present invention.

FIG. 4 is a right lateral view drawing of FIG. 3.

FIG. 5 is a cross-sectional drawing of the glue-less head casing assembly of the present invention; it clearly shows a distal end area of a head socket presses inwardly to reduce the diameter thereof.

FIG. 6 is a cross-sectional drawing of the unity between the head casing main body and the head socket of the present invention.

FIG. 7 is a drawing of the second exemplary embodiment of the glue-less head casing assembly of the present invention; it shows a cross-sectional drawing of the connection between the head casing main body and a lashing ring.

FIG. 8 is an exploded view drawing of FIG. 7.

FIG. 9 is a lateral view drawing of the glue-less head casing assembly of the present invention; it shows that the lashing ring is of a C-type.

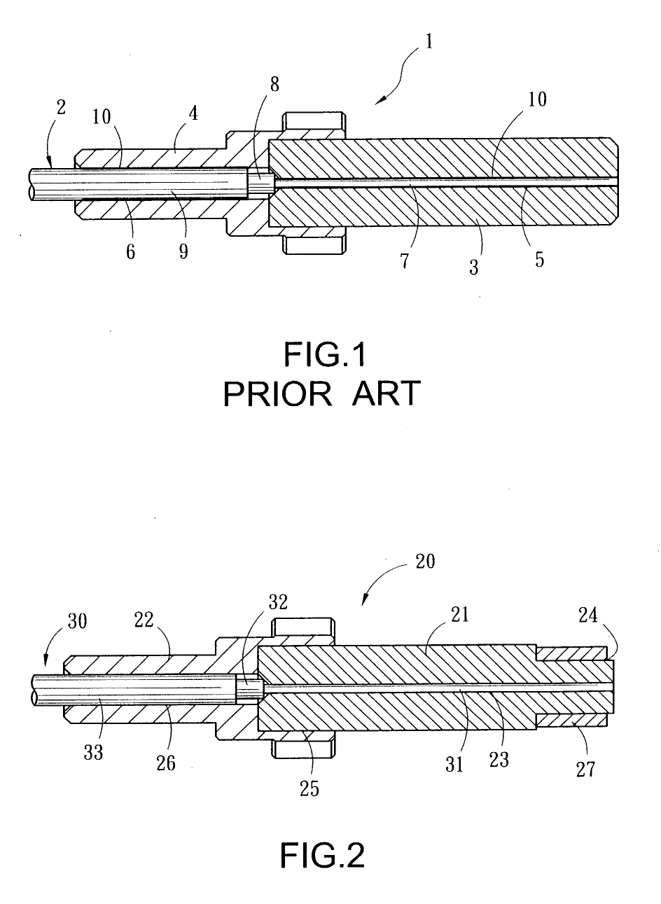

### DETAILED DESCRIPTION OF THE PREFERRED EMBODIMENTS

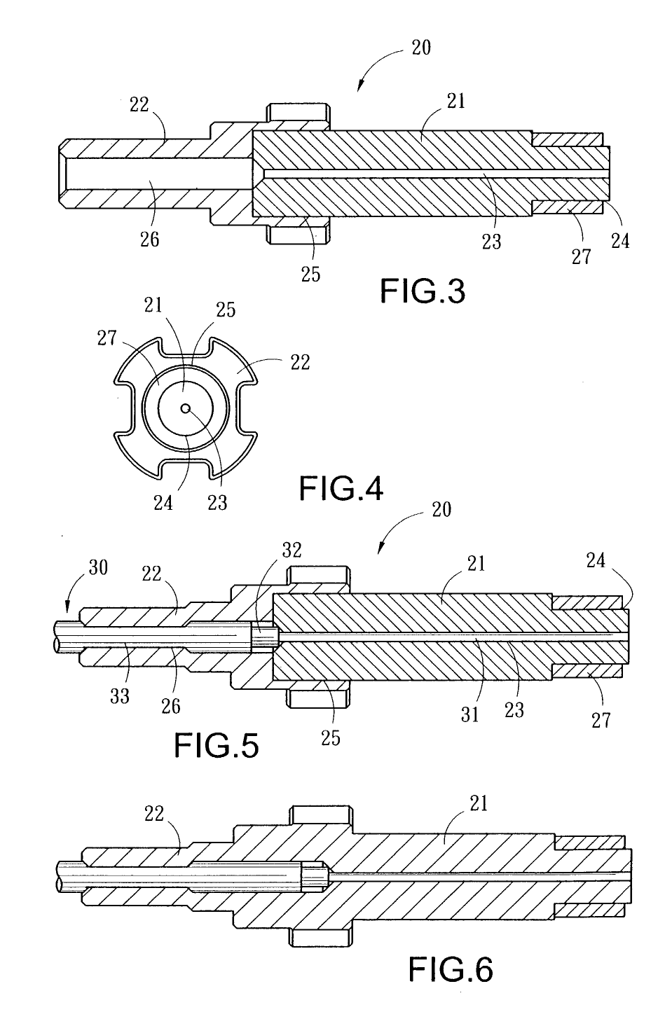

Referring to FIGS. 2 to 5, the present invention of a glue-less head casing assembly (20) of an optical fiber transmission cable is provided for connecting with an optical fiber conductor wire (30). The optical fiber conductor wire (30) has at least one optical core wire (31), a shielding layer (32) covering the outer portion of the optical fiber core wire (31) and a buffering layer (33) covering the outer portion of the shielding layer (32). When in use, parts of the shielding layer (32) and the buffering layer (33) have to be removed to expose a certain length of the optical fiber core wire (31).

The head casing assembly (20) comprises a head casing main body (21 and a head socket (22). The head casing main body (21) is an elastic tube element sintered by powdered ceramic material; a through receiving slot (23) is disposed inside the head casing main body (21); an annular groove (24) is formed on the outer wall at the front end of the head casing main body (21).

The head socket (22) is made of metal material disposed with a adjacent and communicated bearing slot (25) and a channel hole (26); the distal end of the head casing main body (21) inserts into the bearing slot (25) thereby fixedly connecting the head casing main body (21) and the head socket (22) as well as leading the channel slot (26) toward the receiving slot (23) of the head casing main body (21).

In order to connect the head casing assembly (20) and the distal end of the optical fiber conductor wire (30), the optical fiber core wire (31) exposed outwardly extends into the receiving slot (23) and the buffering layer (33) extents into the channel slot (26) when the optical fiber conductor wire (30) inserts into the head casing assembly (20). A lashing ring (27) of a hollow circular tube shape with an O-type cross section is disposed on the annular groove (24); the size of the inner diameter of the lashing ring (27) is slightly smaller than that of the outer diameter of the annular groove (24). Therefore, when the optical fiber conductor wire (30) completely inserts into the head casing assembly (20), the lashing ring (27) inserted on the annular groove (24) forcefully and tightly connects the front end area of the head casing main body (21) and the optical fiber core wire (31). The diameter of the distal end of the head socket (22) is reduced by a squeezing tool for tightly connecting the distal end with reduced diameter and the buffering layer (33) of the optical fiber conductor wire (30).

As indicated in FIG. 6, the head casing main body (21) unites with the head socket (22) into one unit.

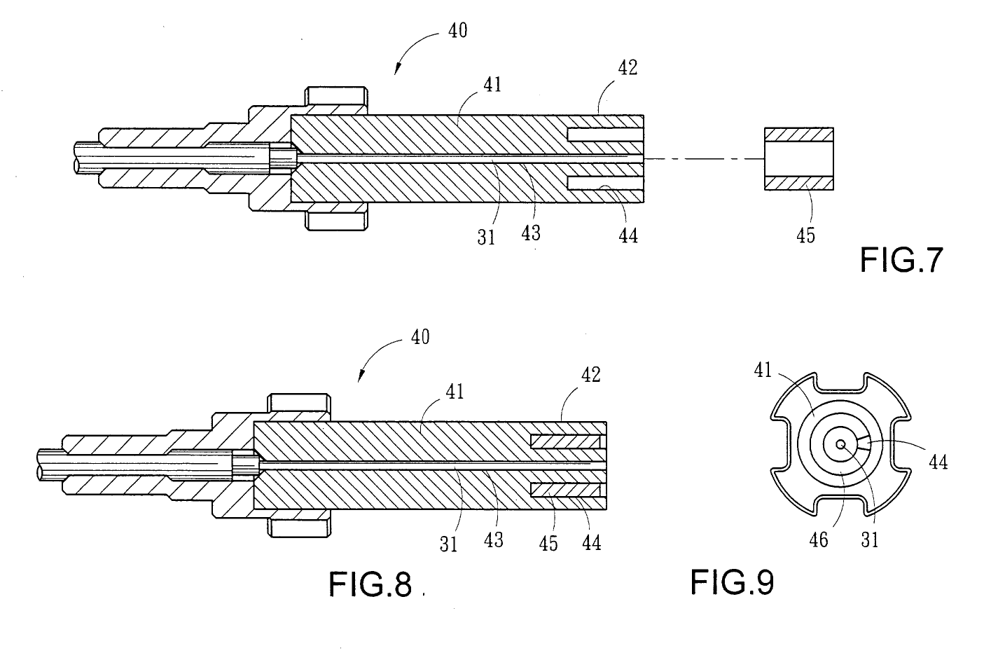

FIGS. 7 and 8 show the second exemplary embodiment of the present invention of a glue-less head casing assembly (40) of an optical fiber transmission cable. An annular grove (44) forms between the outer wall (42) at the front end of a head casing main body (41) and a receiving slot (43). A lashing ring (45) is disposed on the annular groove (44). The relative dimension between the annular groove (44) and the lashing ring (45) forcefully and tightly connects the front end area of the head casing main body (41) and the optical fiber core wire (31). The cross section of the lashing ring (45) is of an O-type or a C-type, as indicated in FIG. 9.

In summation, the head casing assembly of the present invention is suitable for electric cables of any sizes. Using a lashing ring inserted at the front end of the head casing main body tightly connects said front end area and the optical fiber core wire of the optical fiber conductor wire. Furthermore, applying a squeezing tool at the distal end of the head socket to forcefully reduce the diameter of the distal end area achieves the objective of tightly connecting said distal end area and the buffering layer of the optical fiber conductor wire. This kind of tight connecting is suitable for the head casing assembly of any type. Once the head casing assembly connects with the optical fiber conductor wire, an optical fiber transmission cable or an optical fiber jump joint wire is formed such that the head casing main body of the head casing assembly easily connects with the optical fiber adapter thereby increasing the distance of optical fiber communication and stabilizing the transmission of the optical signals.

It is of course to be understood that the embodiment described herein is merely illustrative of the principles of the invention and that a wide variety of modifications thereto may be effected by persons skilled in the art without departing from the spirit and scope of the invention as set forth in the following claims.

1. A glue-less head casing assembly of an optical fiber transmission cable is provided for connecting with an optical fiber conductor wire; the optical fiber conductor wire has at least one optical core wire, a shielding layer covering the outer portion of the optical fiber core wire and a buffering layer covering the outer portion of the shielding layer; the head cashing assembly comprising:
a head casing main body with a front end, a distal end and a receiving slot axially extending between the front end and the distal end;
a head socket connecting with the distal end with the head casing main body; a channel slot is disposed therein and leads to the receiving slot of the head casing main body; when the optical fiber conductor wire completely inserts into the head casing assembly, the receiving slot engages the outer portion surface of the optical fiber core wire while the channel slot engages the outer portion surface of the buffering layer; at this time, the distal end of the head socket presses and deforms inwardly till the channel slot and the buffering layer tightly connect;
a lashing ring is disposed coaxially at the front end of the head casing main body and forces the front end area of the head casing main body to tightly connect with the optical fiber core wire.

2. The glue-less head casing assembly of an optical fiber transmission cable according to claim 1, wherein the head casing main body and the head socket unites into one unit.

3. The glue-less head casing assembly of an optical fiber transmission cable according to claim 1, wherein an annular groove is formed on the outer wall at the front end of the head casing main body; the lashing ring is disposed on the annular groove.

4. The glue-less head casing assembly of an optical fiber transmission cable according to claim 2, wherein an annular groove is formed on the outer wall at the front end of the head casing main body; the lashing ring is disposed on the annular groove.

5. The glue-less head casing assembly of an optical fiber transmission cable according to claim 1, wherein an annular groove is formed between the outer wall at the front end of the head casing main body and the receiving slot; the lashing ring is disposed on the annular groove.

6. The glue-less head casing assembly of an optical fiber transmission cable according to claim 2, wherein an annular groove is formed between the outer wall at the front end of the head casing main body and the receiving slot; the lashing ring is disposed on the annular groove.

7. The glue-less head casing assembly of an optical fiber transmission cable according to claim 1, wherein the cross section of the lashing ring is of an O-type.

8. The glue-less head casing assembly of an optical fiber transmission cable according to claim 2, wherein the cross section of the lashing ring is of an O-type.

9. The glue-less head casing assembly of an optical fiber transmission cable according to claim 5, wherein the cross section of the lashing ring is of a C-type.

10. The glue-less head casing assembly of an optical fiber transmission cable according to claim 6, wherein the cross section of the lashing ring is of a C-type.
